(19) United States
(12) Patent Application Publication
(10) Pub. No.: US 2007/0135120 A1
(43) Pub. Date: Jun. 14, 2007

(54) FIXED CELLULAR TERMINAL - WIRELESS LOOP SYSTEM

(76) Inventors: Dennis King, Sacramento, CA (US); Mark N. Rosen, Auburn, CA (US); Wojciech B. Lewalski, Sacramento, CA (US)

Correspondence Address: GROSS & ASSOCIATES, 1415 L STREET SUITE 1000, SACRAMETO, CA, 95814, US

(21) Appl. No.: 11/548,667

(22) Filed: Oct. 11, 2006

Related U.S. Application Data
(60) Provisional application No. 60/725,735, filed on Oct. 11, 2005.

(51) Int. Cl. H04Q 7/20

(52) U.S. Cl. 455/426.2

(57) ABSTRACT

A device that provides a gateway between a public switching telephone network and a gateway device comprises a controller interface including telephony circuitry, power circuitry, and a master cellular phone circuit. The controller is connected to at least one public switching network. The controller interface further includes a plurality of cartridge slots connected to the telephony circuitry and the master cellular phone circuitry, wherein the telephony circuitry links the master cellular phone circuitry to the public switching telephone network. The device further includes a plurality of transceiver cartridges removeably connected to the cartridge slots of the controller interface. The transceiver cartridges are operably configured to wirelessly link the master cellular phone circuitry to the cellular networks. Additionally, the controller interface circuitry is operably configured to switch between land line telephone network and the plurality of cellular networks based on preset conditions.

### CROSS REFERENCE TO RELATED APPLICATION

This application is a nonprovisional application of U.S. Application No. 60/725,735, filed on Oct. 11, 2005, which is incorporated, in its entirety, herein by reference.

### BACKGROUND OF THE INVENTION

1. Field of Invention

The present invention relates to fixed cellular terminal device.

2. Description of Related Art

A fixed cellular terminal (FCT) is an apparatus designed to be used in a fixed location and allows the user the ability to use a standard telephone handset, fax machine or personal computer (PC) to transmit voice and data over a cellular network as an alternative or back-up to a standard wire line telephone service. FCTs provide an interface between the user's analog devices (standard home or office phone) and a cellular transceiver. When the FCT is connected to the analog devices and the cellular transceiver a Wireless Local Loop (WLL) is created. The interface emulates the functions of a standard wire line telephone service for dial tone, detection of closed circuit for “on-hook” or “off-hook” condition and power so that a keypad of the analog device such as a standard telephone handset can be used the same as the keypad of a mobile handset to access control functions of the transceiver. FCT, as a rule, are not designed to provide features such as personal data storage, short message service (SMS) or gaming like many mobile cellular devices. These types of features are dictated by the external devices connected to the FCT.

Conventional FCTs manufactured today have several features in common such as; no requirement of push to send or end a call by a user, wherein the send or end call is detected by a closed or open circuit (line voltage) created by the standard telephone handset, Fax or modem. Other features common of conventional FCTs are; the simulation of the dial tone upon lifting of the handset, initiation of fax machine or modem; the power requirement is alternating current (AC) with battery back-up. Further, conventional FCTs typically do not include service features such as voice mail, call waiting and call forwarding. These features are provided by the cellular service network. Most conventional FCT also combine the interface and radio transceiver into a single device. Additionally, conventional FCT devices typically operate on a single network platform such as Code Division Multiple Access (CDMA) or Global System for Mobility (GSM).

A deficiency with conventional FCTs is that they are limited to one cellular network at a time. If a user wants to change to a different cellular network, the user has to cease operation, switch the cellular network by replacing the cellular device and then conduct the call. Further, conventional FCTs lack the ability to operate with multiple cellular networks and platforms simultaneously.

A further deficiency inherent with conventional FCTs is the inability to easily upgrade as cellular network technology upgrades. Conventional FCTs must either entirely be replaced or a complete new cellular device must be installed.

Still an additional drawback of conventional FCTs is that while conventional FCTs can select between the least cost of the installed cellular network and the public switched telephone network (landline), conventional FCTs are limited to the cellular network installed. If a different cellular network has cheaper rates, conventional FCTs cannot access them.

Another deficiency with conventional FCTs is their limited ability to conduct data transmissions. Since conventional FCTs have only one cellular network multi-tasking ability is limited. For example, conventional FCTs operating on a network that does not have high data capability can not take advantage of a network capable of high data rates without changing networks or devices.

### SUMMARY OF THE INVENTION

The present invention overcomes the drawbacks and shortcomings of conventional fixed cellular telephone devices. The present invention is a fixed cellular terminal or Wireless Local Loop (WLL) with a plurality of cellular network circuits or cellular transceiver cartridges and standard telephone wire lines. The present invention is designed to provide the user with greater flexibility resulting in increased functional capabilities and a least cost method to change service providers, change network platforms and to easily upgrade the FCT device. Conventional FCTs require the entire unit to be replaced in order to change or upgrade networks. The novelty of present invention's FCT device rests in the use of a plurality of removable and interchangeable cellular transceiver cartridges. Each of the transceiver cartridges contains a cellular transceiver and essential control circuitry. The FCT has a main circuit board configured with circuitry and firmware designed to allow access and control of the cellular transceiver cartridge control circuitry, provide power to the transceiver cartridge and facilitate antenna connections. The transceiver module is preferably installed in a protective plastic casing designed to be inserted into a base interface unit of the FCT, wherein terminals enter a socket, which provides a connection to the main circuit board of the base interface unit.

Some of the primary features of present invention are: the device can be used with any combination of a plurality of transceiver cartridges and a plurality of telephone service lines; the device can be used on a variety of network platforms or service providers at the same time; the device provides a least cost upgrade method by requiring only the transceiver cartridge to be replaced; and, the FCT when installed in an optional wall mount bracket will provide a fail safe (power off) connection to a standard wire line telephone service hard wired between building telephone service entrance and building telephone wiring.

Additionally, in a preferred embodiment, a FCT is provided such that a user may select a type of service priority for automatic line number assignment for standard wire line telephone service, cellular service or cellular back-up for wire line service by a manual switch. The Fixed Cellular Terminal device made in accordance with the present invention also allows common nine pin (DB-9) connectors, universal serial bus (USB) 2.0 and RJ-45 data connectors to support the “always on” capabilities of third generation (broadband) cellular technology deployed by network providers.

The present invention is a device for providing a gateway between a public switching telephone network and a plurality of cellular network. The device of the present invention comprises a controller interface including telephony circuitry, power circuitry, and a master cellular phone circuitry. The controller is connected to at least one public switching network. Additionally, the controller interface includes a plurality of cartridge slots connected to the telephony circuitry and the master cellular phone circuitry, wherein the telephony circuitry links the master cellular phone circuitry to the public switching telephone network. Further the present invention includes a plurality of transceiver cartridges removeably connected to the cartridge slots of the controller interface. The transceiver cartridges are operably configured to wirelessly link the master cellular phone circuitry to the cellular networks. The device further includes an output from the controller interface; an input to the controller interface; a user mode select switch disposed on the controller unit; a power supply connected to the power circuitry of the controller interface; and, an antenna assembly connected to the antenna circuitry of the controller interface, wherein the controller interface circuitry is operably configured to switch between land line telephone network and the plurality of cellular networks based on preset conditions.

The present invention further discloses a transceiver cartridge device comprising a housing; a cellular phone circuitry disposed within the housing; and, a connecting terminal operably configured to engage the controller interface; wherein the transceiver cartridge device is operably configured to engage a controller interface operably configured to receive the transceiver cartridge.

Still, another aspect of the present invention discloses a fixed cellular terminal (gateway) system, wherein the system includes a fixed cellular terminal (FCT), wherein the FCT includes a controller interface including telephony circuitry, power circuitry, and a master cellular phone circuitry, the controller being connected to at least one public switching network. The controller interface further includes a plurality of cartridge slots connected to the telephony circuitry and the master cellular phone circuitry; (the telephony circuitry links the master cellular phone circuitry to the public switching telephone network). The device further includes a public switching telephone network connection; a cellular transceiver cartridge, wherein the cellular transceiver cartridge is removeably connected to the cartridge slots of the controller interface, the transceiver cartridges being operably configured to wirelessly link the master cellular phone circuitry to the cellular networks; an antenna connected to the controller interface; a personal computer input within the controller interface; a primary electrical power supply connected to the controller interface; a backup electrical power supply within the controller interface; and, a standard landline phone handset connected to the controller interface.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiments of this invention will be described in detail, with reference to the following figures, wherein:

FIG. 1 is a block diagram of an exemplary embodiment of the present invention;

FIG. 2 is a perspective view of a fixed cellular terminal device according to a preferred embodiment of the present invention;

FIG. 3 is a front view of the device shown in FIG. 1;

FIG. 4 is a rear view of the device shown in FIG. 1;

FIG. 5 is a top view of the fixed cellular terminal device made in accordance with the present invention;

FIG. 6 is a side view of the fixed cellular terminal device made in accordance with the present invention;

FIG. 7 is a cross-section view taken along line 7-7 in FIG. 5;

FIG. 7A is a cross-section view taken along line 7A-7A in FIG. 5;

FIG. 8 is an explode perspective view of a cellular transceiver cartridge of the fixed cellular terminal device made in accordance with the present invention;

FIG. 9 is a top view of the cellular transceiver cartridge of FIG. 8;

FIG. 10 is a side view of the cellular transceiver cartridge of FIG. 8;

FIG. 11 is a rear view of the cellular transceiver cartridge of FIG. 8;

FIG. 12 is a rear perspective view of the cellular transceiver cartridge of FIG. 8;

FIG. 13 is a cross-section view of the cellular transceiver cartridge taken along line 13-13 inf FIG. 9

FIG. 14 is a wiring diagram of a system incorporating the fixed cellular terminal device made in accordance with the present invention;

FIG. 15 is a schematic diagram of the system in FIG. 7 installed in a structure;

FIG. 16 is a flowchart which illustrates the circuit logic for the transceiver cartridge installation and configuration of the device made in accordance with the present invention;

FIG. 17 is a flowchart which illustrates the circuit logic for a call termination and completion; and,

### DETAILED DESCRIPTION OF THE PREFERRED EMBODIMENTS

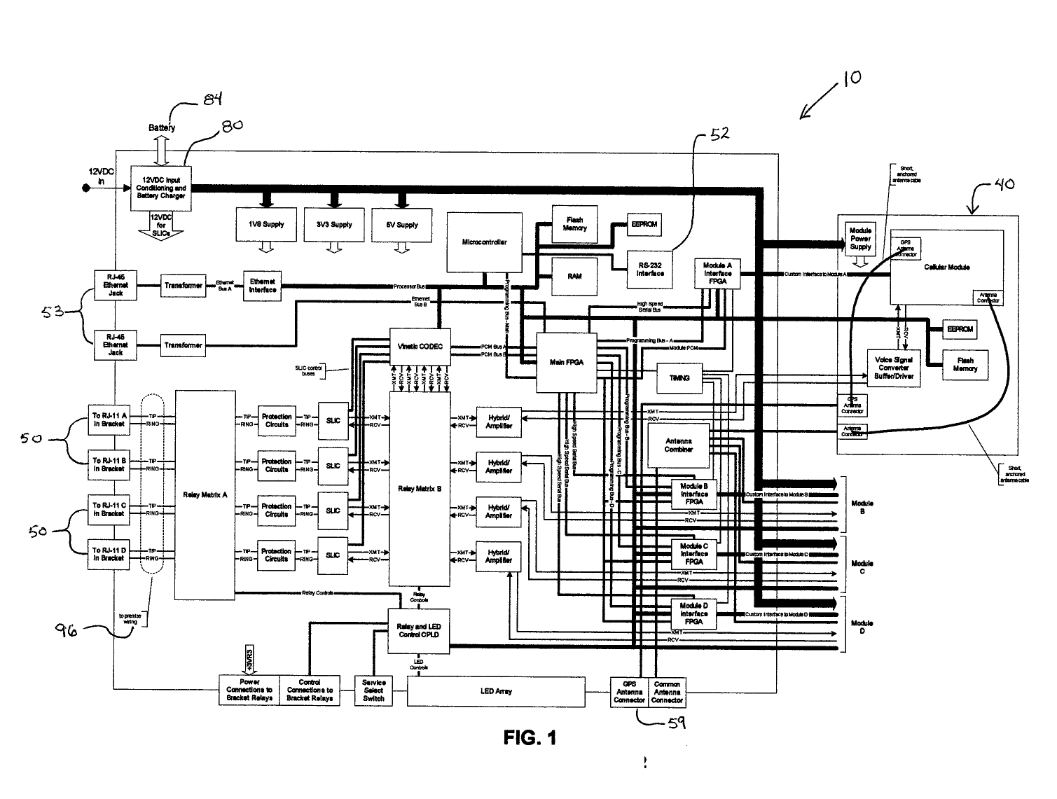

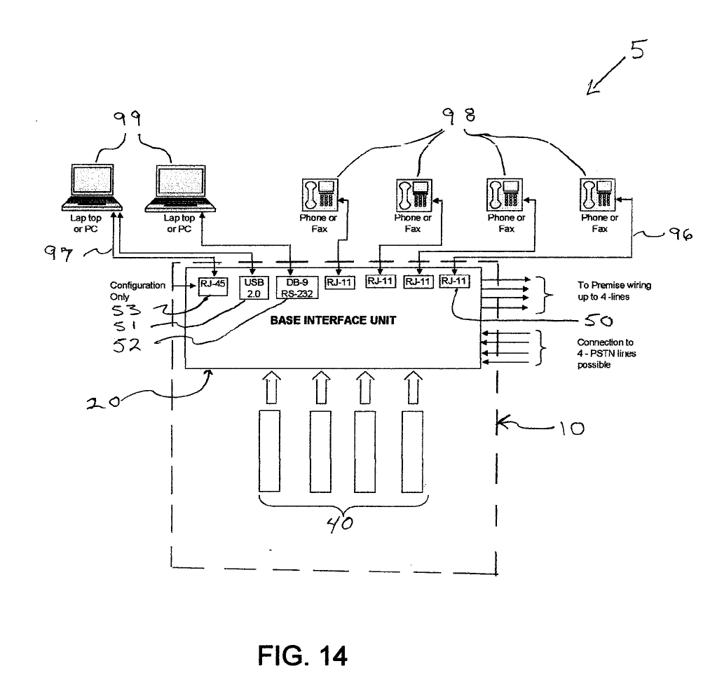

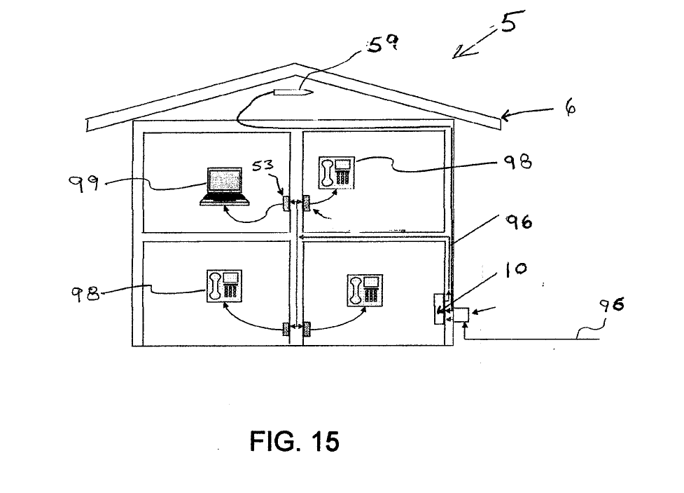

FIG. 1 is a block diagram of an exemplary embodiment of a fixed cellular terminal (FCT) made in accordance with the present invention showing the major components of the device 10 comprising: a base unit 20 and a plurality of transceiver cartridges 40. The device 10, when in use is connected to a public switched telephone network (PSTN) connection 96; and, at least one telephone 98 and is a system 5, as shown in FIGS. 14 and 15.

The transceiver cartridges 40 are a module type that are inserted into the base unit 20. The cartridges 40 make connections to a variety of cellular networks depending on the cellular provider and will be discussed below in further detail. The PSTN 96 is a standard landline or Plain Old Telephone Service (POTS) installed in most buildings connected to the base unit 20.

The telephone or handset 98 is a common telephone as used in homes or offices. The telephone 98 is connected to the base unit 20 through a RJ-11 phone jack 50. It should be appreciated that in other various exemplary embodiments, the present invention could be use with cordless phones systems that include a base connected to PSTN 96.

The FCT further comprises: a plurality of data ports; a plurality of antennae 59; and a power supply 80. The power supply includes a standard AC power adapter 82 to provide electrical power to the base unit 20 and a backup battery 84, which is a DC type battery that provides electrical power backup in the case the AC power supply is lost.

The data ports 49 include a universal serial bus (USB) ports 51, a RS-232 port 52, and a RJ-45 data port 53. The data ports 49 provide connector locations for a variety of peripheral, components to be connected to the base unit 20, such as, but not limited, to, computers for example. The antenna 59 provides increase cellular signal reception.

The FCT device 10 made in accordance with the present invention allows a user to access a plurality of cellular telephone networks or data devices through the use of the removable transceiver cartridges 40 inserted into the FCT device 10. The user can pick up the handset 98 from connected to the device 10 and the FCT 10 will automatically choose among the plurality of networks, either cellular phone networks or the PSTN 96, for the least cost of the call. Similarly, the user can through a cellular phone, make a call at the least cost as the FCT 10 will choose the cellular network or PTSN 96 with the least cost. Additionally, the FCT 10 will provide emergency phone connectivity if the PSTN service 96 is out of order by using one of the plurality of cellular networks.

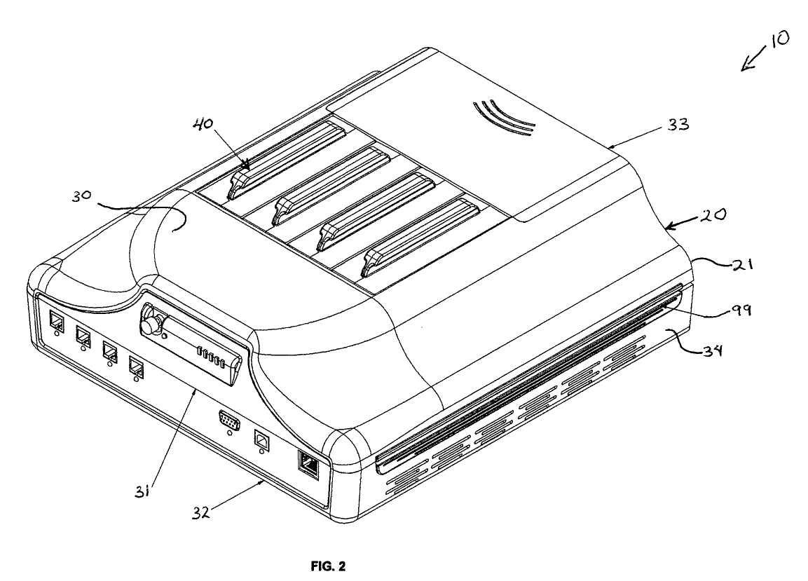

FIGS. 2 through 7 depict an exemplary embodiment of the FCT device 10 made in accordance with the present invention. The FCT 10, as shown in FIGS. 2 through 5, includes the base interface unit or controller 20, the plurality of cellular transceiver cartridges 40 and the power supply (not shown).

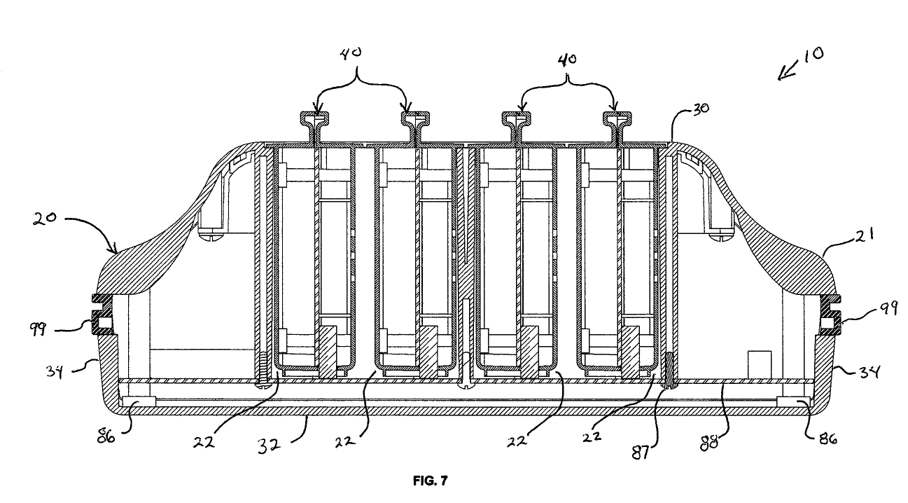

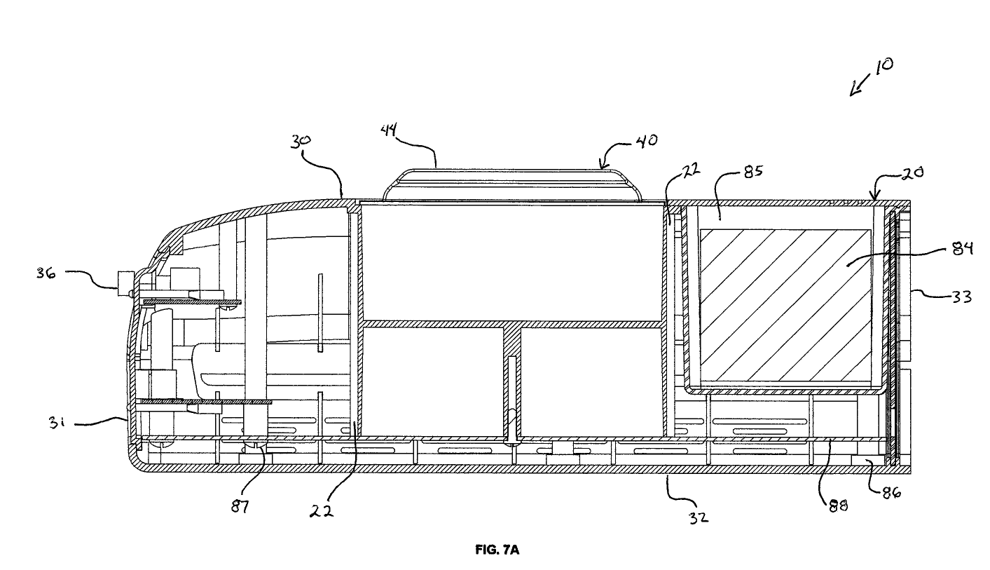

Referring again to FIGS. 2 through 7, the base interface unit 20 consists of a casing 21, a plurality of cartridge slots 22 (FIG. 7), wherein each slot 22 includes slot terminals (not shown) for completing an electrical connection between the base unit 20 and the transceiver cartridge 40. Further the base unit 20 includes all interface circuitry to facilitate the access of the FCT 10 to the transceiver cartridge 40, and power supply circuitry to supply electrical power for all the components of the FCT 10. The base unit 20 further contains circuitry, see FIG. 1, antenna connections and firmware to configure the base interface unit 20 for each individual cellular transceiver cartridge 40.

The casing 21 is the body of the base interface unit 20 and is constructed out of a high impact resistant plastic such as, but not limited to Acrylonitrile Butadiene Styrene Plastic (ABS), or other such plastic common in the art of plastic enclosures. The casing has a top surface 30, a case front surface 31, a case bottom surface 32, a case back surface 33 and opposing sides 34. It should be appreciated that in other various exemplary embodiments, other materials, which provide a rugged, durable dust proof and water resistant enclosure may be used for the base unit 20.

As shown in FIG. 3, the case front surface or face plate 31 has disposed in the face plate 31 a plurality of RJ-11 standard female phone connectors 50, the Universal Serial Bus (USB) 2.0 female, connector 51, the nine-pin RS-232 female connector 52, and the RJ-45 female Ethernet net connector 53. It should be appreciated that in other various exemplary embodiments, the above listed connections could be disposed on any of the surfaces of the FCT. Further, it should be appreciated that in other various exemplary embodiments, the number of and connector types could vary depending on the type of peripheral devices the user may want to connect to the FCT.

The face plate 31 further has disposed on the face plate 31 a on/off power switch 36, a plurality of L.E.D. status indicator lights 58, a plurality of L.E.D. mode indicator lights 72 and a L.E.D. signal strength indicator light 74. It should be appreciated that the above mentioned switch and indicator lights could be disposed on other surfaces of the case such as, but not limited to, the case top surface or one of the case side surfaces. The face plate 31 additionally includes a four pin dip switch for manual mode selection, which is not shown.

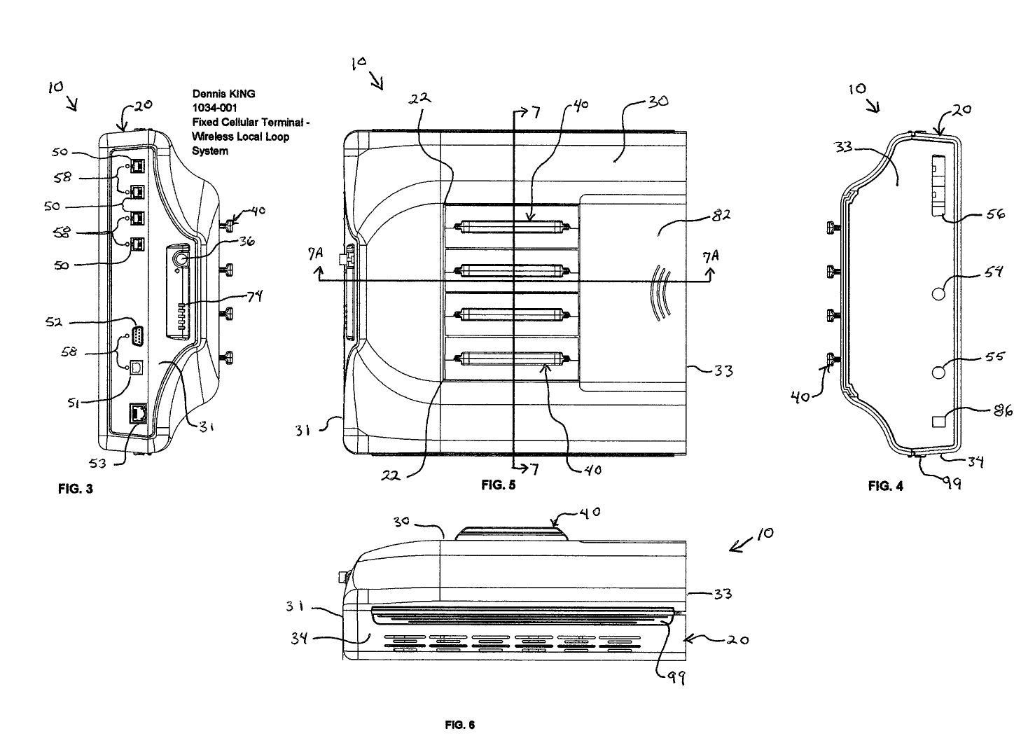

The back surface or back plate 33, as shown in FIG. 4, has disposed on the back plate 33 a power supply connector 86, a antenna connector 54, an assisted Global Positioning System (aGPS) antenna connector 55, and a DB-37 (thirty-seven pin) connector 56. It should be appreciated that in other various exemplary embodiments, other type of connectors now in use or developed in the future may be used.

As shown in FIG. 5, disposed on the top surface 30 of the casing 21 are the plurality of cartridge slots 22. In the preferred embodiment, the plurality of cartridge slots 22 are installed perpendicular to the top surface 30 of the casing 21. The cartridge slots 22 further have slot terminals (not shown) operably configured to receive corresponding connectors on the transceiver cartridge 40. It should be appreciated that in other various exemplary embodiments, the cartridge slots could be installed non-perpendicular to the top and in other locations within the casing.

Additionally, the opposing sides 34, as shown in FIG. 6, of the casing 21 are operably configured to receive a wall mount bracket (not shown). A mount rail 99 is disposed on each side 34 of the casing 21 and operably configured to engage the wall mount bracket.

The casing 21 made according to the present invention has a size of generally about four inches high, eleven inches wide, and twelve inches long. It should be appreciated that in other various exemplar embodiments, the casing could be of other dimensions.

The casing 21 further includes blank covers (not shown) for insertion into slots 22 when transceiver cartridges 40 are not inserted. The blank covers provide protection of the slot terminals.

Further, the base unit 20 includes a first member 88, as shown in FIG. 7. The first member or plate 88 houses all the circuitry for the base unit 20. The plate 88 is secured to the base unit 20 by fasteners 87 to the top portion 30. The plate 88 rests on posts 86, which are disposed on the bottom 32.

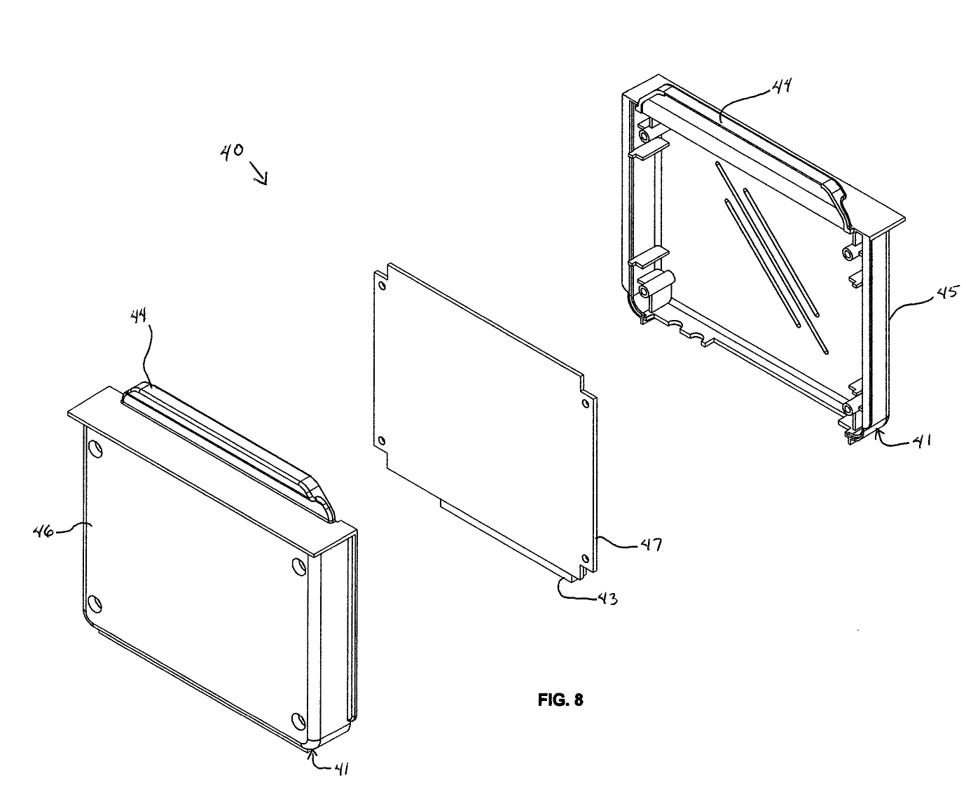

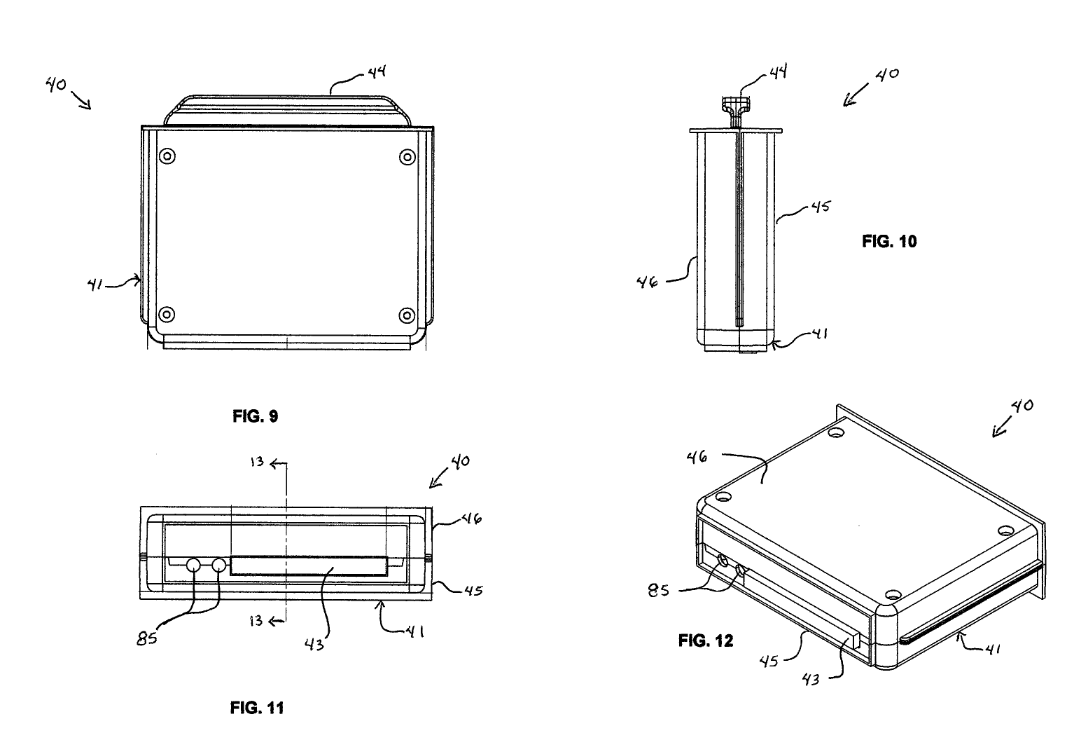

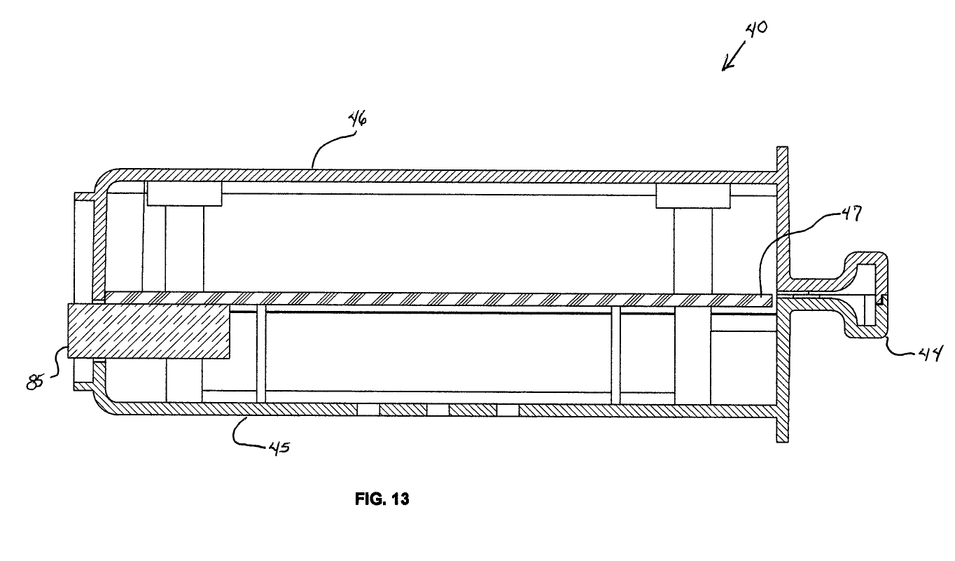

Referring to FIGS. 8 through 13, the cellular transceiver cartridges 40 includes a casing 41, a cellular transceiver module, terminal connectors 43, wherein the terminal connectors 43 are operably configured to engage the slot terminals.

The cartridge 40 circuitry is installed in the casing 41. The casing 41 is constructed out of a high impact resistant plastic such as, but not limited to Acrylonitrile Butadiene Styrene Plastic (ABS), or other such plastic common in the art of plastic enclosures. The transceiver cartridge casings 41 are operably configured to electrically connect the cartridge 40 with the slot terminal 23 when the cartridge 40 is inserted into the slot 22 on the base interface unit 20. A plurality of the cartridges 40 can be used in the base interface unit 20 to provide the user with cellular phone network access. FIG. 2 shows the cartridges 40 installed in the base interface unit 20. In the preferred embodiment four cartridges 40 are installed to provide four independent cellular connections.

In the preferred embodiment, the cartridges 40 are generally about 1¼ inches in width, by 4½ inches in length and 3 inches in height. It should be appreciated that in other various exemplary embodiments, the cartridges 40 could be of other dimensions.

Each cellular transceiver cartridge 40 is a separate cellular phone circuit. It should be appreciated that in other various exemplary embodiments the cartridges could include modules for other devices such, as, but not limited to, wireless fidelity 802.11 (WiFi) networks or others common in the art or that may be developed in the future. Each cartridge 40 could also be from the same cellular network provider, different network providers or a combination. Therefore, the FCT 10 may be operated with a variety of cellular network platforms or service providers at the same time as determined by the cartridges 40 inserted in the base unit 20.

The transceiver cartridges 40 do not require any other actions other than inserting the cartridges 40 into the slots 22 of the base interface unit 20 or pulling to remove the cartridges 40 by the user. The cartridges 40 are a plug-and-play type of cartridge, meaning that the user has only to insert the cartridge 40 into the slot 22 for the cartridge 40 to operate.

The transceiver cartridges 40 are hot swappable, wherein the user can change out a cartridge 40 without affecting any remaining cartridge 40 or interrupting service to or from the remaining modules 40. This feature of the present invention allows for the simultaneous use of a plurality of cartridges from different cellular networks, a plurality of cartridges from the same cellular network, data only cartridges or any combination thereof.

It should be appreciated that in other exemplary embodiments, the transceiver cartridges could be installed within the base unit and not easily accessible by the user. In such an embodiment, the cartridges would still be exchangeable by the removing of a cover plate.

Another benefit of the transceiver cartridges 40 is that the user still has use of the user's personal cellular phone. Conventional FCTs require the cellular phone of the user to be connected to the FCT during a call.

As a cellular network provider upgrades its cellular circuit infrastructure. The FCT 10 can be easily upgraded by just changing the respective cellular transceiver cartridge 40. This procedure allows the user a least cost method to upgrade by requiring only the transceiver cartridge 40 to be replaced. Similarly, if a cartridge 40 should malfunction, the repair is simply replacing the malfunctioning cartridge 40 with a new one.

The cellular transceiver cartridges 40 include an antenna connection 85 for the use of an antenna combiner contained in the base interface unit 20 to simplify the system installation. External antenna connections are designed for use with exterior high gain antenna systems to compensate for signal loss due to cable length and the combiner. In the preferred embodiment no antenna amplifiers are used. However, it should be appreciated that in other various exemplary embodiments, antenna amplifiers may be used.

The transceiver cartridge(s) 40 are designed for voice services and meet cellular emergency 911 (E911) requirements and Telephone Device for the Deaf (TDD/TTY) protocols, as well as will be licensed and approved by FCC, service providers and network operators.

The cartridge 40 further includes a first portion 45, a second portion 46, and a handle 44. Disposed between the first and second portions 45 and 46, is a printed circuit board 47. The cellular telephone circuitry is mounted to the printed circuit board 47. Further, the cartridge terminal 43 and cartridge antenna connector 85 are disposed on the printed circuit board 47.

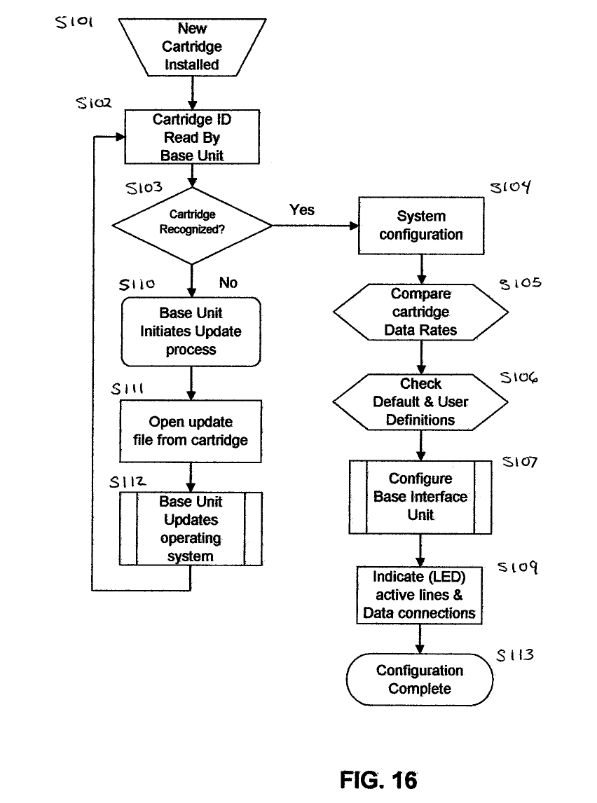

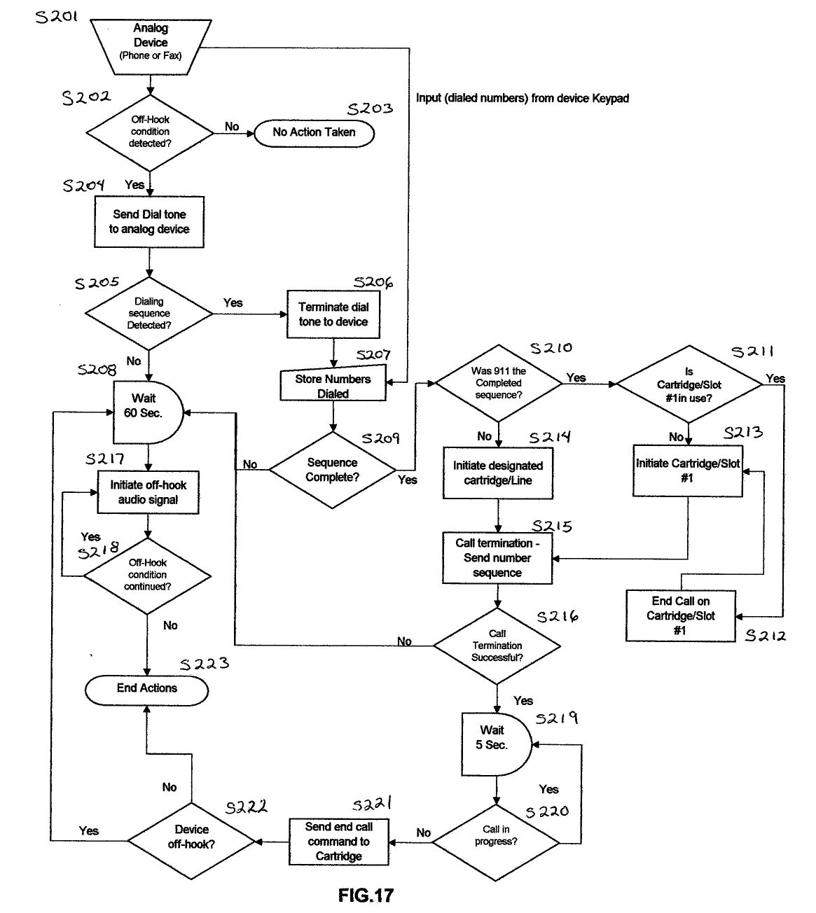

FIG. 16 shows the method steps of how the base interface unit 20 recognizes the installation of the transceiver cartridge 40. The execution of the steps shown is completed by the software loaded in the base interface unit 20.

Further, the FCT 10 includes a plurality of industry standard RJ-11 phone jacks 50, universal serial buses (USB) 2.0 ports 51, RS-232 ports 52 and RJ-45 Ethernet connections 53. It should be appreciated that in other various exemplary embodiments, other state of the art electrical and communication connections may be included within the base interface unit.

FIGS. 14 and 15 depict an exemplary embodiment of the FCT 10 in use as a FCT system 5 in accordance with the present invention. The present invention is also know as a Wireless Local Loop (WLL) system as shown in FIGS. 14 and 15. It should be appreciated that in other various exemplary embodiments, the FCT made in accordance with this invention could have a plurality of circuits or lines.

The system 5, as shown in FIGS. 14 and 15, includes the FCT 10, an external antenna assembly 59, a plurality of POTS telephones 98, and an optional at least one personal computer (PC); or router 99. The FCT 10 further includes an optional wall mount bracket (not shown).

The system 5, as shown in FIG. 15, provides a user with greater flexibility in both of the user's land line telephone and cellular phone resulting in increased functional capabilities and a least cost method to change service providers, change network platforms and to upgrade the device 10 or the system 5.

As shown in FIG. 15, the system 5 is intended to be installed into an existing structure or building 6 and connected to the existing public switched telephone network (PSTN) service 96, such as, but not limited to, a house, office or work trailer. It should be appreciated that in other various exemplary embodiments, the FCT and system may be installed in tents or in an open atmosphere.

The RJ-11 phone jacks 50 as shown in FIGS. 3 and 14, allow the user to connect to the FCT 10 standard phone set, fax machines or other analog telecommunications equipment. The base interface unit 20 provides the respective RJ-11 telephone jacks 50 with a voltage output equal to that of a public switched telephone network (PSTN) to allow operation of standard telephone 96, Facsimile (fax) machine or other analog device. The preferred embodiment of the FCT 10 as shown in FIG. 2 has four RJ-11 jacks 50 and is configured for a combination of up to four standard phone sets 98, fax machines or other analog telecommunication devices. It should be appreciated that in other various exemplary embodiments, one or more RJ-11 jacks may be installed in the device 10 allowing an increase in component connections.

Still referring to FIGS. 3 and 15, the USB 2.0 port 51 and RS-232 port 52 (industry common nine-pin DB-9) ports and RJ-45 Ethernet connections XX allow the user to connect the PC or router 99 to the FCT 10. The user may use the PC 99 to configure the FCT 10 operations, as will be discussed later. The present invention has one USB 2.0 port 51 and one RS-232 DB-9 port 52, as shown in FIG. 3. It should be appreciated that in other various exemplary embodiments, one or more USB 2.0 and RS-232 ports may be installed in the device 10. The user may connect to the Internet through the FCT 10 by use of the PC 99 once the PC 99 is connected to the FCT 10 as mentioned above.

The user is provided a means to configure the system 5 by using the RJ-45 Ethernet connection 53 and the PC 99 to set up line assignments, least cost call routing and other custom call routing features.

The FCT 10 has several operation modes or functions, which include, but not limited to; Public Switched Telephone Network (PSTN) or standard wire line telephone service priority mode; cellular service priority mode; cellular back-up mode; and, advanced user defined settings. The operational modes of the FCT 10 allow the user to assign line priority (line number position) based on the type of phone service most used.

The operation modes or functions of the FCT 10 can be controlled either by the four pin dip switch 24, as shown in FIG. 2, or by the PC 99 when connected to the FCT 10. The operating modes of the FCT 10 will be most applicable when the FCT 10 is installed in a permanent fixed location and hardwired between the structure 6 PSTN service entrance and the structure 6 telephone wiring 96.

The user of the FCT 10 may select the system default mode for the type of service priority for automatic line number assignment for standard wire line telephone service, cellular service or cellular back-up for wire line service by a manual switch. The types of service priority modes are unique to the present invention.

The FCT 10 provides the user with a least cost call routing, which routes a call depending on the call destination by selecting the least cost of one of the plurality of the cellular network providers or the PSTN. Conventional devices also provide a least cost routing, however, conventional devices are limited to the least cost between one cellular network and the PSTN. The features of the present invention allow the FCT 10 to select from multiple cellular network providers and the PSTN for the least cost call routing.

Further, the FCT 10 operates as a cellular back-up to a wire line service 96, wherein the FCT 10 will detect a failure of the PSTN service 96 and activate a cellular cartridge 40 to operate until the PSTN service 96 is restored. An example would be, if an intruder cuts telephone line 95 to prevent, alarm notification; the FCT 10 and the system 5 would back-up the PSTN allowing the alarm signal to go out by activating the cellular module 40 in slot number 1 and assigning to RJ-11 Line number 1.

Additionally, the FCT 10 can support the “always on” capabilities of third generation (broadband) cellular technology through the DB-9 52 and USB 2.0 51 connections.

The PSTN priority mode of the FCT 10 assigns standard telephone service lines 95 to the RJ-11 telephone jacks 50 on the base interface unit 20 or structure wiring in line number order first before assigning cellular cartridges 40. The PSTN priority mode is used when the user desires to have their primary service provided by standard wire line service 96. An example of the PSTN priority mode would be when the user prefers to have line number 1 provided by a standard telephone company for local calls and has line number 2 provided by cellular service which they use for long distance calls to take advantage of the lower long distance rates.

The cellular priority mode of the FCT 10 assigns cellular service cartridges 40 to the RJ-11 telephone jacks 50 on the base interface unit 40 or structure wiring in line number order first before assigning PSTN lines 96. The cellular priority mode is used when the customer prefers to have cellular service as their primary service. An example of the cellular priority mode would be the customer uses cellular service for voice calls on line number 1 to take advantage of the low cost service providing unlimited local and long distance calling and has digital subscriber line (DSL) service on Line number 2 where high data rates may be too costly using cellular.

Additionally the cellular back-up allows for uninterrupted service for calls in or out if call forwarding is available on the wire line service 96. The FCT 10 would place the wire line phone number on call forward to the active cellular cartridge's phone number. This mode would most often be used where an alarm system is in use and requires access to a phone line or in cases where phone service must always be maintained.

The fourth mode of the FCT 10 is the user defined line assignments. Through the use of the PC 99 and software provided with the FCT 10, the user may assign telephone service lines 96 and cellular cartridges 40 to any of the RJ-11 telephone jacks 50 on the base interface unit 20 including the assignment of specified cellular cartridges 40 as back-up in any configuration desired. Since most standard RJ-11 telephone jacks 50 in buildings are only capable of operating 2 lines at a time, the service line may be split to different wall jacks. For example, the user defined line assignments mode would be to provide each wall jack 50 with a cellular line and a DSL line by sending line number 1—Cellular and line number 2—(PSTN) DSL to one wall jack and sending line number 3—cellular and line number 2—PSTN (DSL) to the other wall jack. The user defined line assignments as described can be done if the building has minimum standard 4-pair wiring. This method is also used to configure and implement least cost call routing. FIG. 17 depicts a flowchart detailing this method. The processes of FIG. 17 can be preformed by the software installed in the base interface unit 20.

The user can control the FCT 10 configuration through the use of the PC 99 connected by the RJ-45 Ethernet connection. FCT 10 configuration allows the user to select line assignments, least cost call routing and other custom call routing features.

The base interface unit 20 provides all common components necessary to interface with the analog devices and any of the cellular transceiver cartridges 40 installed. The processing and switching capability exceeds the operational requirements as described herein to allow the maximum flexibility to upgrade the FCT 10 by use of only firmware, software and cartridges 40 to upgrade for future multimedia applications and Quality of Service (QoS) provided by third generation (3G) network (i.e. CDMA 2000 1X EV-DO (Data optimized) and Universal Mobile Telecommunications System (UMTS) deployment and the Internet Protocol (IP) multimedia subsystem (IMS).

The base interface unit 20 detects the presence or installation of transceiver cartridges 40 and/or active standard wire line telephone service. The unit 20 will then automatically configure the FCT 10 for the transceiver cartridge 40 installed based on data rate provided by a cartridge ID function. The cartridge ID function is provided by firmware in the cartridge 40.

Additionally, the base interface unit 20 self-configures for operation with cellular cartridges 40 and PSTN service 96 based on the three position manual switch 24 for Cellular, PSTN, or Cellular back-up modes; or, an advanced line number position configuration determined by user through the use of the PC 99 and provided management software. The base unit 20 further indicates status of respective RJ-11, RJ-45, RS-232 and USB connections by use of LED indicator light 72. In this preferred embodiment, the LED indicator lights 72 have the following meanings:
A) RED—no PSTN or Cellular service.
B) GREEN—for active cellular transceiver cartridge 40 and service.
C) Blinking Yellow—Cellular Transceiver 40 is in roaming status
D) YELLOW—for PSTN or standard wire line service.

Continuing, the base interface unit 20 also displays radio signal strength using a LED bar display 74. At least one transceiver cartridge 40 must be installed and an antenna must be connected.

The base interface unit 20 incorporates the RJ-11 connectors 50 to facilitate the use of a standard analog telephone hand sets, fax machines or other analog devices. Service to each RJ-11 may be provided by one of the cellular transceiver cartridges 40 or one of the PSTN lines 96. Use of the RJ-11 connectors 50 provides the connection from the cellular cartridges 40 to the standard telecommunications devices 98 as shown in FIGS. 14 and 15. The PC 99 would not normally be used with the RJ-11 connectors 50 connections unless the PSTN line 99 is active, wherein it might be used as a dial-up or DSL connection. This may require additional configuration depending on user's Internet Service Provider's (ISP) requirements.

To place outgoing calls or faxes, the base interface unit 20 detects a closed circuit or the initiation of the standard telecommunications device 98. Once the closed circuit is detected, the base interface unit 20 initiates a dial tone to the analog device 98. Upon detection of the first dial tone from the standard telecommunications device 98, the base interface unit 20 ceases the dial tone. The base interface unit 20 then converts the tone to a corresponding number or digital signal, which is temporarily stored until the dialing sequence is complete. Examples of typical dialing sequences are, but not limited to, seven digit local phone numbers; common quick dials such as 911, 411 and 611; eleven digit phone numbers for long distance preceded by 1 or appropriate country codes; and, commands preceded by # or *. Upon completion of the dialing sequence, the base interface unit 20 initiates the corresponding transceiver cartridge 40 and transfers dialing sequence to corresponding transceiver cartridge 40. The dialing sequence is silenced to standard telecommunications device 98.

After the dialing sequence has been transferred to transceiver cartridge 40 (modem), the base interface unit 20 facilitates the connection between the standard telecommunications device 98 to the cellular transceiver cartridge 40. The base interface unit 20 monitors connection until an open circuit is detected at the standard telecommunications device 98 or an end call is received from the cellular transceiver cartridge 40. Upon detection of open circuit or no signal the interface unit 20 discontinues the active link between devices and places the standard telecommunications device 98 in standby. If a transceiver 40 signal is not present and circuit is closed to standard telecommunications device 98, interface unit 20 sends an audible tone to device after specified time to indicate connection has been terminated and standard telecommunications device 98 is “off hook”.

In the event of an incoming call, the transceiver cartridge 40 will send a signal to the base interface 20. The base interface unit will cause a ring tone to the corresponding standard telecommunications device 98.

Upon detection of a closed circuit from the standard telecommunications device 98 the interface unit 20 facilitates voice or data transmission to the transceiver cartridge 40. The interface monitors the connection until an open circuit is detected at the analog device or end call signal is received from the transceiver cartridge 40. Upon detection of open circuit or ended call signal the interface unit 20 discontinues the link between the standard telecommunications device 98 and the cartridge 40. If transceiver cartridge 40 signal is not present and circuit is closed to standard telecommunications device 98, interface unit 20 sends an audible tone to device after specified time to indicate connection has been terminated.

The base interface unit 20 incorporates the RJ-45 connectors 53, RS-232 connectors 52 and USB connectors 51 to provide the fastest connection possible under a second generation (2G) and second and a half generation (2.5G) platforms (14-174 Kbps) with the ability to increase data rates when 3G platforms (2 Mbps) become available. The installed, cellular transceiver cartridge 40 determines which type of connection can be used. The FCT 10 allows the PC 99 to connect directly to the transceiver cartridge 40 when using 2.5G and 3G (data only) platforms. Due to lower data rates of 20 and 2.5G platforms a form of caching within the FCT 10 has been provided for completion of internet upload/down load allowing the PC 99 to be disconnected from the FCT 10. The FCT 10 configures the data connections based on a transceiver cartridge identification (ID) code to optimize data transfer rates by always routing the data connection to the cartridge(s) 40 with the highest data transfer capability. If multiple cartridges 40 are being used, the FCT 10 will have the ability connect to multiple data connectors.

The interface unit 20 can detects the presence of a spherical device connected to a data connection such as the PC 99. The FCT 10 determines the capabilities of the cartridge 40 being used and supports the “always on” capability of 2.5G & 3G networks by allowing a connection as direct as possible to appropriate transceiver cartridge 40 for higher data speeds if transceiver cartridge 40 is detected to be a data only cartridge (i.e. CDMA 2000 1X EV-DO).

Further, the FCT 10 can switch data connections to the transceiver cartridge 40 with the higher data rate; for example, if one of the slots 22 contains a transceiver cartridge 40 designed for voice and low data (14.4 kbs) and one of the other slots 22 contains a transceiver cartridge 40 for data (CDMA 2000 1X EV-DO), the second slot 22 will route to the appropriate data connector. The interface unit 20 indicates the appropriate data connector by use of the LED status light 58. The LED status lights 58 have the following meanings:
A) RED—No service or Low data (14.4 Kbps) to connector
B) Yellow—Medium data rate (100 Kbps to 175 Kbps)
C) Blinking yellow—Roaming
D) GREEN—High Speed data available

The base interface unit 20 further includes a processor 25. The processor 25 has related circuitry and a central processing unit (CPU), which is capable of monitoring and executing instructions for all connections and cartridges 40 in a time frame not noticeable to the user. The processor 25 also includes a main circuit board 26, which is a printed circuit board (PCB) of proprietary design. Some considerations for the design of the main circuit board 26, but not limited to are size of board, heat generated and operating tolerances.

Other main board 26 features include 64 Mega Bites (MB) flash memory 27 for system programming (firmware), wherein the flash memory 27 size was determined by the amount of flash memory 27 needed for initial anticipated programming plus two times that size to allow for future program enhancements, plus for caching of uploaded files so that the PC 99 may be disconnected from the FCT 10 while large files are being uploaded to internet. In the preferred embodiment, the system operating platform of the FCT 10 has been designed for Linux operating systems. It should be appreciated that in other various exemplary embodiments, other operating systems common in the art may be used.

Additionally, it should be appreciated that in other various exemplary embodiments the main circuit board 26 is contemplated to have the ability be compatible with all foreseeable future upgrades of cellular platforms; switching capabilities to route input/output from transceiver cartridges 40 to appropriate RJ-11 or data (RJ-45, RS-232, USB 2.0) connections; and, the main circuit board 26 includes full multimedia capabilities to facilitate video or digital TV input/output. It should be appreciated that in other various exemplary embodiments, full multimedia capabilities to facilitate video or digital TV input/output is optional.

The cellular transceiver cartridges 40 provide the user with the least cost method to upgrade to new cellular platforms or to change service providers. Utilizing the cartridges 40 containing only the transceiver with related control circuitry in a compact cartridges the cost to the consumer to upgrade is greatly reduced since only new cartridges 40 need to be purchased rather than replacing the entire FCT 10. Additionally cartridges 40 may be swapped out for different area codes so the user can avoid long distance calls when the FCT 10 is moved to new locations. It should be appreciated that in other various exemplary embodiments the transceiver cartridges could be proprietary transceiver cartridges designed for the base interface unit 20 by other vendors.

The system 5 further includes a plurality of antennae, which connect to the FCT 10 to the connectors on the back plate 33. In the preferred embodiment, the FCT 10 has two antennae for operation of the system 5. It should be appreciated the in other exemplary embodiments, one or more antennae may be used depending on the modes of operation desired by the user.

The system 5 includes a standard antenna 59 type “TNC” connector, (not shown). The standard antenna is operably configured as an external mount antenna, wherein the antenna or antenna cable is connected by a type “TNC” connector to the base unit 20 so that the cables may be easily removed by the user.

The FCT 10 made in accordance with the present invention contemplates that the standard antenna design configuration supports the plurality of cellular transceivers cartridges 40, wherein the base unit 20 incorporates connection to a radio frequency combiner integral to the circuitry within the base interface unit 20 to facilitate the standard antenna being used for the plurality of cellular transceiver cartridges 40.

The standard antenna comprises an external high gain antenna, which provides greater signal reception to the base unit 20 and is less susceptible to interference from buildings and other obstructions. The present invention contemplates three optional standard antenna designs. One antenna design is a standard omni-directional style directly mounted to the base unit 20. A second antenna design is a directional high gain directional exterior antenna shelf mount assembly such as, but not limited to a Yagi or flat panel style antenna. A third antenna design is an omni directional exterior antenna, which is known in the art as a marine style.

Additionally, the base unit 20 provides connections for an assisted Global Positioning System (aGPS) antenna 59, as shown in FIG. 15. The aGPS antenna 59 in the preferred embodiment is for the aGPS system in the transceiver cartridge 40 and is an optional configuration. The aGPS system antenna 59 is required if the user desires to access the emergency response network. The aGPS system is required for all voice centric devices to meet federal (FCC) and service provider requirements for emergency response (E-911) programs. The aGPS connector 55 is a type, “TNC” connector disposed on the back panel 33.

The base interface unit 20 further includes a battery 84 (as shown in FIG. 7A) and a power unit (as shown in FIG. 1), which are located internal to the base unit 20. The power unit 80 within the base unit 20 also includes conventional battery charger circuitry to charge the battery. The power unit provides a constant trickle charge to keep the battery 84 at the battery's required voltage.

The FCT 10 receives electrical power by an Alternating Current (AC) power adaptor (not shown) which plugs into the base interface unit 20. The AC power adaptor is an off-the-shelf type, wherein the power requirements from the AC power adaptor are 120V AC input, 15 VDC output, at one amp. The AC power adaptor includes a DC to AC transformer.

The AC Power adaptor connects to the base interface unit 20 by the power connector 84 disposed on the rear of the base unit 20 operably configured to receive the male barrel connector of the AC power adaptor.

The base interface unit 20 further includes a battery compartment 85 and a battery compartment access panel 82, as shown in FIGS. 2, 5 and 18, wherein the battery serves a back-up power supply to the FCT 10 in the event of loss of electrical power by the AC power adaptor. The battery access panel 82 allows access of the battery compartment 85 from external of the base unit 20 for removal and replacement of the battery if required.

The battery 84 is a commercial off-the-shelf wherein the battery has a 12 volt, 3.4 amp-hour rating. Additionally, the battery 84 in the preferred embodiment is a sealed lead-acid type. It should be appreciated that in other various exemplary embodiments, the battery may be types such as but not limited to NiCad or lithium such as are common in the art so long as the battery meets the power requirements. An example of the battery, but not limited to, is a POWER SONIC model number 1230 or equivalent.

The device 10 may be employed as a desk or table top unit or mounted on a wall by use of the optional wall mounting bracket, not shown. The wall bracket is hardwired to the existing structure 6 wiring to provide a docking station for the FCT to plug into and quickly be connected to the PSTN service and 96 the structure wiring 6. The wall mount bracket includes first terminal (not shown), wherein the first terminal are configured to engage the standard PSTN service connections, and a second terminal (not shown), wherein the second terminal is configured to engage the structure wiring.

The base unit 20 of the FCT 10 can be inserted into the optional wall mount bracket. The DB-37 connector 56 disposed on the back plate 33, as shown in FIG. 3, is self aligning to the DB-37 connector on the top of the bracket circuitry enclosure. The bracket circuitry possesses terminals so the mounting bracket circuitry can be hard wired to the structure 6 PSTN service entrance and the structure 6 wiring 96, as shown in FIG. 15. The mount bracket provides a pass-thru for PSTN service to building wiring 96 when the FCT 10 is not installed or power is off. When the FCT 10 is inserted in the bracket, power is provided to the mounting bracket circuitry relays causing PSTN service 95 to be routed through the base interface unit 20 and service is provided to the structure 6 wiring by the FCT 10 based on mode or user defined settings.

Once plugged into the wall mount bracket the FCT 10 provides cellular service to the structure 6. When the FCT 10 is not in the wall bracket, or in the event of a power failure, the wall bracket allows the PSTN line 96 to function normally with the structure wiring and allowing the wall bracket to become passive.

The wall mount bracket connections to both the structure and the FCT 10 allow for the FCT 10 to receive and send directly to the structure PSTN wiring 96. An active wire line 96 is fed directly into the base unit 20 so that calls can be routed efficiently.

The circuitry of the optional wall bracket provides a fail safe (power off) mode for the FCT 10 and the system 5. The fail safe mode connection provides a power off mode between standard PSTN telephone service 96 and the FCT 10 to allow standard PSTN connections in the event of a power failure. This is important where phone service must always be maintained such as in an alarm system or in a service industry where users must be able to reach the other users at all times.

Further, the wall bracket allow removal of the FCT 10 from the bracket and allows the PSTN wiring 96 to continue working (fail safe). This is also important when the FCT 10 is not always used, such as in the case of a temporary office trailer if PSTN service is readily available, the FCT 10 may not be used. If PSTN is not available, the bracket simplifies installation with premises wiring. The bracket can remain wired to the premises whether the FCT 10 is used or not

The base interface unit 20 of the FCT 10 further includes a plurality of software sets. The present invention includes four sets of software. A first set of software, base interface unit operating firmware controls the basic operation of the base interface unit 20. A second set of software, the cartridge operating firmware, controls the configuration and identification of the cellular transceiver cartridges 40. A third set of software, user interface (management) software, controls the user configuration of the FCT 10 and the fourth set of software, installation and upgrade software, controls the manufacture's programming and upgrades. It should be appreciated that in other various exemplary embodiments, various configurations of software may be employed, such as but not limited to, one version of software that controls all operations.

The base interface unit 20 operating firmware provides instruction for the self-configuration of the base interface unit 20 and the transceiver cartridge(s) 40. The base interface unit operating firmware further, provides call processing capability and user interface of the FCT 10 through the personal computer 99. The base interface unit operating firmware also includes the internal circuitry to allow routing of installed cartridges 40 to appropriate line positioning; ability to detect installed, cellular transceiver cartridges 40, PSTN lines, and detect call activity. Further the base interface unit operating firmware processes call activation protocols and access protocols for internet access.

The cartridge 40 operating firmware communicates with the base interface unit 20 the type of transceiver cartridge 40 installed. The cartridge operating firmware provides information such as, but not limited to, the type of cartridge 40 installed, the cartridge data rate, etc. The cartridge operating firmware further provides to the base unit 20 the proper pin connection routing.

The user interface (management) software is provided to the user on a compact disc (CD) for loading on the personal computer 99. The user management software allows the user to configure the FCT 10 operations meet to the user's needs. The user management software permits the user to; select line assignments for cellular and PSTN service, define call routing based on phone numbers called to provide least cost call routing; setup calling instructions for call forwarding of cellular cartridge for use in the cellular back-up mode; and, allows the user to obtain FCT status information.

The installation and upgrade software provides the manufacture of the FCT 10 the ability to load the base interface unit operating firmware, cartridge operating firmware, and default user interface (management) software are settings. The installation and upgrade software further provides the ability to upgrade the software sets when patches are generated. The upgrades to software can be obtained by the user online via the internet. The installation and upgrade software provides for, but not limited to; FCT unit identification database with fields for serial number, software version loaded, date, and time of last load; software loading instructions for automatic loading of software once unit information is entered; the FCT 10 information retrieval and verification instructions during an on-line upgrade; audible user instructions for update procedures when dial-up is used; and, automatic installation of update or patch once a begin code is received.

If should be appreciated that the present invention could be configured with different alternative embodiments. For example, the transceiver cartridges could be internally mounted to the base unit thereby requiring removal of the top of the base unit for the cartridges to be change. Another alternative exemplary embodiment could include a wireless Fidelity (WiFi) connection to a cellular phone and a computer. Further, in another alternative exemplary embodiment, the base unit could have two portions, wherein a first portion would contain the software to run and program the base unit and the second portion would contain the hardware and cartridges.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A device for providing a gateway between a public switching telephone network and a plurality of cellular networks, comprising:
a controller interface including telephony circuitry, power circuitry, and a master cellular phone circuitry, the controller being connected to at least one public switching network, the controller interface further includes a plurality of cartridge slots connected to the telephony circuitry and the master cellular phone circuitry, wherein the telephony circuitry links the master cellular phone circuitry to the public switching telephone network;
a plurality of transceiver cartridges removeably connected to the cartridge slots of the controller interface, the transceiver cartridges being operably configured to wirelessly link the master cellular phone circuitry to the cellular networks;
an output from the controller interface;
an input to the controller interface;
a user mode select switch disposed on the controller unit;
a power supply connected to the power circuitry of the controller interface; and,
an antenna assembly connected to the antenna circuitry of the controller interface,
wherein the controller interface circuitry is operably configured to switch between land line telephone network and the plurality of cellular networks based on preset conditions.

2. A device as recited in claim 1, wherein the transceiver cartridges are operably configured to transmit data.

3. A transceiver cartridge device comprising:
a housing;
a cellular phone circuitry disposed within the housing; and,
a connecting terminal operably configured to engage the controller interface;
wherein the transceiver cartridge device is operably configured to engage a controller interface operably configured to receive the transceiver cartridge.

4. The transceiver cartridge device as recited in claim 3, wherein the transceiver cartridge device further comprises a data transmitter circuitry within the housing.

5. A fixed cellular terminal (gateway) system, wherein the system includes:
a fixed cellular terminal (FCT), wherein the FCT includes a controller interface including telephony circuitry, power circuitry, and a master cellular phone circuitry, the controller being connected to at least one public switching network, the controller interface further includes a plurality of cartridge slots connected to the telephony circuitry and the master cellular phone circuitry; (the telephony circuitry links the master cellular phone circuitry to the public switching telephone network);
a public switching telephone network connection;
a cellular transceiver cartridge, wherein the cellular transceiver cartridge is removeably connected to the cartridge slots of the controller interface, the transceiver cartridges being operably configured to wirelessly link the master cellular phone circuitry to the cellular networks;
an antenna connected to the controller interface;
a personal computer input within the controller interface;
a primary electrical power supply connected to the controller interface;
a backup electrical power supply within the controller interface; and,
a standard landline phone handset connected to the controller interface.

6. The fixed cellular terminal (gateway) system, as recited in claim 5, wherein the transceiver cartridge is operably configured to transmit data.
